(19) United States
(12) Patent Application Publication
(10) Pub. No.: US 2013/0260836 A1
(43) Pub. Date: Oct. 3, 2013

(54) MOBILE ELECTRONIC DEVICE

(71) Applicant: KYOCERA CORPORATION, Kyoto (JP)

(72) Inventors: Hiroshi TSUNODA, Osaka (JP); Masaki IZAWA, Osaka (JP); Takashi OSANAI, Osaka (JP)

(73) Assignee: KYOCERA CORPORATION, Kyoto (JP)

(21) Appl. No.: 13/845,754

(22) Filed: Mar. 18, 2013

(30) Foreign Application Priority Data
Mar. 28, 2012 (JP) 2012-074445

(51) Int. Cl. H04M 1/02

(52) U.S. Cl. CPC H04M 1/0266
USPC 455/566

(57) ABSTRACT

A mobile electronic device and methods are disclosed. A display module is disposed on a first surface of a housing. A sound output module generates vibrations based on received sounds and transfers the vibrations to a second surface of the housing opposed to the first surface. A touch detection module detects a touch operation performed by a user on the display module. An operation determination module determines the kind of the touch operation during the telephone communications with another device. A function execution module executes a function assigned to the determined kind of the touch operation. The function relates to the telephone communications.

### CROSS-REFERENCE TO RELATED APPLICATION

The present application claims priority under 35 U.S.C. §119 to Japanese Patent Application No. 2012-074445 filed on Mar. 28, 2012, entitles “MOBILE TERMINAL DEVICE, PROGRAM AND CONTROL METHOD OF MOBILE TERMINAL DEVICE”. The content of which is incorporated by reference herein in its entirety.

### FIELD

Embodiments of the present disclosure relate generally to mobile electronic devices, and more particularly relate to mobile electronic device comprising touch panel.

### BACKGROUND

There are conventionally known a mobile phone that includes a touch panel and executes various application programs (hereinafter, referred to as “applications”) according to operations performed on the touch panel. The touch panel includes a display and a touch sensor covering the display. Such a mobile phone includes a speaker and a microphone used for telephone communications on the front surface side of the device as with the touch panel. On a telephone communications, when a user puts the mobile phone to his/her ear, the touch panel is faced toward the user's ear (face).

During telephone communications, the touch panel displays a communication screen including operation buttons for executing various functions relating to telephone communications such as the function of adjusting the receiver volume.

However, when the user holds the mobile phone to his/her ear, the touch panel is faced toward the ear, and thus it is difficult for the user to operate the operation buttons on the touch panel. To operate the operation buttons, the user needs to release the mobile phone from the ear, and possibly also needs to stop conversations with a communication partner.

### SUMMARY

A first aspect of the present invention relates to a mobile electronic device capable of telephone communications with another device. The mobile electronic device according to this aspect includes: a display module disposed on a first surface of a housing; a sound output module operable to generate vibrations based on received sounds and transfer the vibrations to a second surface of the housing opposed to the first surface, the sound output module being disposed within the housing; a touch detection module operable to detect a touch operation performed by a user on the display module; an operation determination module operable to determine the kind of the touch operation during the telephone communications with the another device; and a function execution module operable to execute a function assigned to the determined kind of the touch operation, the function being relating to the telephone communications.

A second aspect of the present invention relates to a method for operating a mobile electronic device. The method includes: receiving sound data from another device; generating vibrations based on the received sound data; transferring the generated vibrations to a second surface opposed to a first face with a display module, thereby to transfer the sounds to a user; detecting a touch operation performed by the user on the display module; determining the kind of the touch operation during telephone communications with the another device; and executing a function relating to the telephone communications that is assigned to the determined kind of the touch operation.

### BRIEF DESCRIPTION OF THE DRAWINGS

Embodiments of the present disclosure are hereinafter described in conjunction with the following figures, wherein like numerals denote like elements.

The figures are provided for illustration and depict exemplary embodiments of the present disclosure. The figures are provided to facilitate understanding of the present disclosure without limiting the breadth, scope, scale, or applicability of the present disclosure.

FIGS. 1A to 1C are diagrams showing a configuration of a mobile phone according to a first embodiment;

FIG. 2 is a block diagram showing an entire configuration of the mobile phone according to the first embodiment;

FIGS. 3A and 3B are diagrams showing display conditions on a display surface during telephone communications, in a button operation identification mode and a touch operation identification mode, respectively, according to the first embodiment;

FIGS. 4A and 4B are diagrams showing examples of a first assignment table and a second assignment table, respectively, according to the first embodiment;

FIG. 5 is a flowchart showing a process of executing a function relating to telephone communications according to the first embodiment;

FIGS. 6A and 6B are diagrams showing a first assignment table according to modification examples;

FIGS. 7A and 7B are diagrams showing a first assignment table according to modification examples;

FIGS. 8A and 8B are diagrams describing a configuration of a mobile phone according a second embodiment;

FIG. 9 is a block diagram showing an entire configuration of a mobile phone according to a third embodiment;

FIG. 10 is a diagram showing a first assignment table according to the third embodiment;

FIGS. 11A and 11B are diagrams describing a function setting process according to the third embodiment; and

FIGS. 12A and 12B are diagrams describing configurations of mobile phones according to other modification examples.

### DESCRIPTION OF PREFERRED EMBODIMENTS

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, Global Positioning Systems (GPSs) or navigation systems, health equipment, display monitors, or other electronic device that uses a display or a touch panel for displaying information

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

### First Embodiment

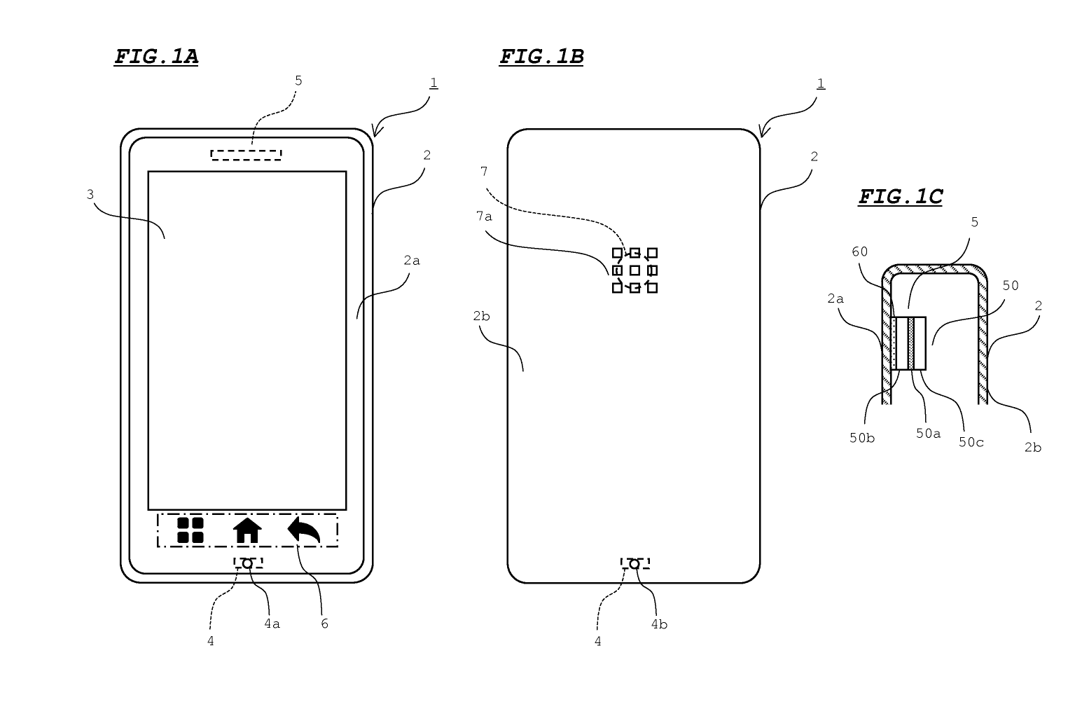

FIGS. 1A and 1C are diagrams showing a configuration of a mobile phone 1. FIGS. 1A and 1B are a front view and a back view, respectively. FIG. 1C is a partial cross-sectional view of a cabinet 2 for showing a configuration of a communication speaker 5.

The mobile phone 1 includes the cabinet 2, a display surface 3, a microphone 4, the communication speaker 5, a key operation part 6, and an external speaker 7.

The cabinet 2 has an almost rectangular outline as viewed from the front side. The cabinet 2 includes on a front surface 2a thereof a display surface 3 of a display module described later. Various images (screens) are displayed on the display surface 3.

The microphone 4 is disposed within the cabinet 2 at one longitudinal end side. In addition, the communication speaker is disposed within the cabinet 2 at the other longitudinal end side.

The cabinet 2 has microphone holes 4a and 4b for taking in sounds on the front surface 2a and a back surface 2b thereof, respectively, at positions opposed to the microphone 4. Sounds taken in from the microphone holes 4a and 4b are input into the microphone 4. The microphone 4 generates electric signals according to the input sounds.

As shown in FIG. 1C, the communication speaker 5 may include a piezoelectric vibration element 50, for example. The piezoelectric vibration element 50 has a bimorph structure with a shim material 50a, a first piezoelectric ceramic plate 50b, and a second piezoelectric ceramic plate 50c. The first piezoelectric ceramic plate 50b and the second piezoelectric ceramic plate 50c are attached to sides of the shim material 50a.

AC voltages are applied to the first piezoelectric ceramic plate 50b and the second piezoelectric ceramic plate 50c. The AC voltage applied to the first piezoelectric ceramic plate 50b and the AC voltage applied to the second piezoelectric ceramic plate 50c are phase-shifted from each other by 180 degrees. With the application of these AC voltages, an operation of extending the first piezoelectric ceramic plate 50b and shrinking the second piezoelectric ceramic plate 50c and an operation of shrinking the first piezoelectric ceramic plate 50b and extending the second piezoelectric ceramic plate 50c are repeatedly performed to vibrate the piezoelectric vibration element 50.

The piezoelectric vibration element 50 is attached by an adhesive 60 to an inner side of the front surface 2a of the cabinet 2.

The piezoelectric vibration element 50 vibrates based on electric signals corresponding to sounds. When the piezoelectric vibration element 50 vibrates, the vibrations based on the sounds are transferred to the front surface 2a of the cabinet 2, thereby to vibrate the front surface 2a. When a user puts the front surface 2a of the cabinet 2 to his/her ear, that is, when the user holds his/her ear close to the front surface 2a or brings his/her ear into contact with the front surface 2a, sound waves generated by vibrations of the cabinet 2 enter into the ear canal through the ear canal hole. The incoming sound waves move in the ear canal and vibrate the ear drum. Accordingly, the user's brain recognizes the sounds. Further, when the user bring his/her ear into contact with the front surface 2a of the cabinet 2, the auricular cartilage vibrates according to vibrations of the cabinet 2, and the vibrations of the auricular cartilage are transferred to the ear drum, thereby to vibrate the ear drum. Accordingly, the user's brain recognizes the sounds.

The vibrations of the front surface 2a of the cabinet 2 are also transferred to the back surface 2b of the cabinet 2. Accordingly, both the front surface 2a and the back surface 2b of the cabinet 2 vibrate, which allows the user to listen to sounds even when the user puts the back surface 2b to his/her ear (when the user holds the back surface 2b close to his/her ear or brings the back surface 2b into contact with his/her ear). However, the volume of sounds from the back surface 2b is slightly lower than the volume of sounds from the front surface 2a.

The cabinet 2 includes a key operation part 6 on the front surface 2a. The key operation part 6 includes a plurality of operation keys. The operation keys are hardware keys, for example. The operation keys are assigned various functions according to a program under execution or the like. For example, when a telephone application is executed to start telephone communications, one of the operation keys acts as a key for switching from a button operation identification mode (described later) to a touch operation identification mode (described later).

The cabinet 2 includes the external speaker 7 therewithin. The cabinet 2 has an output hole 7a on the back surface 2b at a position opposed to the external speaker 7. Sounds output from the external speaker 7 are released to the outside via the output hole 7a.

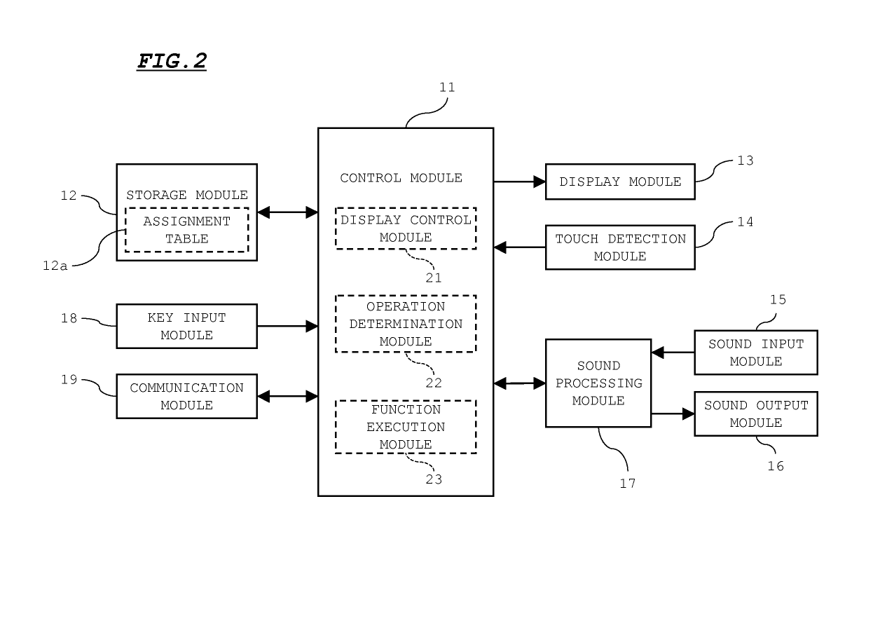

FIG. 2 is a block diagram of an entire configuration of the mobile phone 1. The mobile phone 1 includes a control module 11, a storage module 12, a display module 13, a touch detection module 14, a sound input module 15, a sound output module 16, a sound processing module 17, a key input module 18, and a communication module 19.

The storage module 12 includes a ROM, a RAM, and the like. The storage module 12 stores various programs. The programs stored in the storage module 12 include control programs for controlling components of the mobile phone 1 and various applications (for telephone, e-mail, map, game, schedule management, for example).

The storage module 12 is also used as a working area for storing data temporarily used or generated at execution of a program.

The control module 11 includes a CPU and the like. The control module 11 controls components (the storage module 12, the display module 13, the touch detection module 14, the sound input module 15, the sound output module 16, the sound processing module 17, the key input module 18, the communication module 19, and others) constituting the mobile phone 1 according to the programs.

The display module 13 includes a liquid crystal display and the like. The display module 13 displays an image (screen) on the display surface 3 according to a control signal and an image signal from the control module 11. The display module 13 is not limited to the liquid crystal display but may be any other display device such as an organic EL display.

The touch detection module 14 includes a touch sensor and the like for detecting contact with the display surface 3 by a finger, a touch pen, or the like (hereinafter, referred simply to as “finger”). The touch sensor is integrally formed with the foregoing liquid crystal display to constitute the touch panel. The touch sensor is formed into a transparent sheet and is disposed on the front surface 2a of the cabinet 2 so as to cover the display surface 3. The touch sensor may be any of touch sensors of various types such as an electric capacity type, an ultrasonic wave type, a pressure sensitive type, a resistance film type, and a photo detective type.

The touch detection module 14 detects touch on the display surface 3 by a user. Specifically, the touch detection module 14 detects a position on the display surface 3 contacted by a finger as an input position, and outputs a position signal corresponding to the detected input position to the control module 11.

The user can perform various touch operations by contacting the display surface 3 with his/her finger. The touch operations may include a tap operation, a double tap operation, a long tap operation, a flick operation, a slide operation, and the like. The tap operation is performed by a user contacting the display surface 3 with his/her finger and then releasing the finger from the display surface 3 within a short time. The double tap operation is performed by a user repeating the tap operation twice for a short time. The long tap operation is performed by a user contacting and holding his/her finger on the display surface 3 for a determined time or longer. The flick operation is performed by a user flipping the display surface 3 with his/her finger. The slide operation is performed by a user bringing his/her finger into contact with the display surface 3, and holding and moving the finger in an arbitrary direction. The flick operations in upward, downward, leftward and rightward directions are referred to as an upward flick operation, a downward flick operation, a leftward flick operation, and a rightward flick operation, respectively.

The sound input module 15 includes the microphone 4 and the like. The sound input module 15 outputs electric signals from the microphone 4 to the sound processing module 17.

The sound output module 16 includes the communication speaker 5, the external speaker 7, and the like. The sound output module 16 inputs an electric signal from the sound processing module 17, and outputs sounds from the communication speaker 5 and the external speaker 7. The sounds include various kinds of sounds such as voices and notification sounds.

The sound processing module 17 subjects an electric signal from the sound input module 15 to A/D conversion and the like, and outputs a converted digital sound signal to the control module 11. The sound processing module 17 subjects the digital sound signal from the control module 11 to a decoding process and D/A conversion and the like, and outputs a converted electric signal to the sound output module 16.

When any of the operation keys in the key operation part 6 is pressed, the key input module 18 outputs a signal corresponding to the pressed operation key to the control module 11.

To perform telephone communications and data communications, the communication module 19 includes a circuit for signal conversion, an antenna for radio wave transmission/reception, and the like. The communication module 19 converts a signal for telephone communications or data communications input from the control module 11 into a radio signal, and transmits the converted radio signal via the antenna to a base station or another communication device or the like as a destination of communications. The communication module 19 also converts radio signals received via the antenna into a signal in a form capable of being used by the control module 11, and outputs the converted signal to the control module 11.

In this embodiment, when the user operates an icon for a telephone application or when an incoming call from another mobile phone or the like has reached, the telephone application is activated. Once telephone communications are started, functions relating to telephone communications such as volume adjustment of the communication speaker 5 and recording of communication sounds are executed during the telephone communications according to a predetermined input operation. The mobile phone 1 includes the button operation identification mode as an operation mode for executing the functions relating to telephone communications. In the button operation identification mode, the operation buttons to which the respective functions are assigned are displayed on the display surface 3. When the user touches any of the operation buttons, the function corresponding to the touched operation button is executed. Besides the button operation identification mode, the mobile phone 1 includes the touch operation identification mode as an operation mode. In the touch operation identification mode, the functions are assigned to various touch operations to be performed on the display surface 3. When the user performs a specific touch operation, the function corresponding to the touch operation is executed. The user can implement selectively the button operation identification mode or the touch operation identification mode. The touch operation identification mode corresponds to a first mode of the present invention, and the button operation identification mode corresponds to a second mode of the present invention.

To perform a process for executing the functions relating to telephone communications, the control module 11 includes a display control module 21, an operation determination module 22, and a function execution module 23. Further, the storage module 12 stores an assignment table 12a.

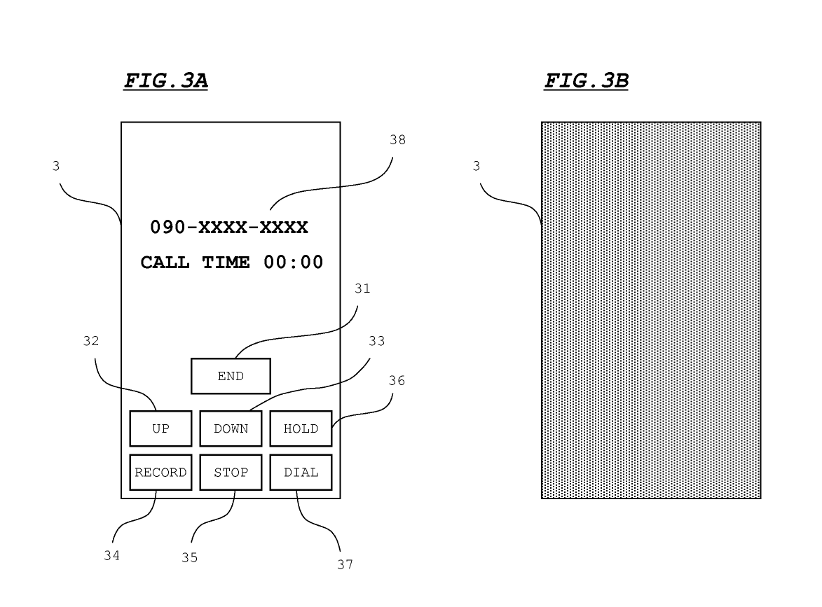

FIGS. 3A and 3B are diagrams showing display conditions on the display surface 3 during telephone communications in the button operation identification mode and the touch operation identification mode, respectively.

The display control module 21 performs display control on the display module 13. The display control module 21 controls the display module 13 and displays on the display surface 3 a communication screen in the button operation identification mode. As shown in FIG. 3A, the communication screen includes an end button 31, an up button 32, a down button 33, a record button 34, a stop button 31, a hold button 36, and a dial button 37. Each of the operation buttons carries an indication of an assigned function such as “up,” “down,” or the like. The communication screen includes communication information 38 such as a telephone number of a communication partner, duration of call, and the like. The display control module 21 further turns off the display module 13 in the touch operation identification mode. Accordingly, the display surface 3 blacks out as shown in FIG. 3B.

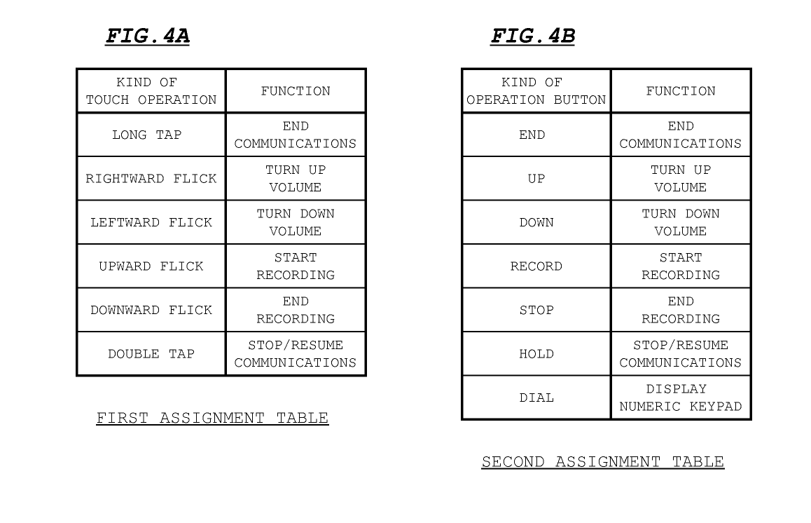

The assignment table 12a includes a first assignment table for use in the touch operation identification mode and a second assignment table for use in the button operation identification mode. FIGS. 4A and 4B are diagrams showing examples of the first assignment table and the second assignment table, respectively.

As shown in FIG. 4A, in the first assignment table, individual functions relating to telephone communications are assigned to individual touch operations for use in the touch operation identification mode. For example, the function “end communications,” “turn up sound volume,” “turn down sound volume,” “start recording,” “end recording,” and “stop/resume communications” are assigned to the touch operations “long tap,” “rightward flick,” “leftward flick,” “upward flick,” “downward flick,” and “double tap,” respectively.

As shown in FIG. 4B, in the second assignment table, individual functions relating to telephone communications are assigned to the individual operation buttons. For example, the function “end communications,” “turn up sound volume,” “turn down sound volume,” “start recording,” “end recording,” “stop/resume communications,” and “display numeric key pad” are assigned to the end button 31, the up button 32, the down button 33, the record button 34, the stop button 35, the hold button 36, and the dial button 37, respectively.

The operation determination module 22 determines the kind of a touch operation on the basis of results of detection by the touch detection module 14 in the touch operation identification mode. For example, when, after detection of an input position, the input position is not detected any longer within a predetermined first time, the operation determination module 22 determines that a tap operation is performed. When a tap operation is detected twice within a predetermined second time, the operation determination module 22 determines that a double-tap operation is performed. When, after detection of an input position, the input position is continuously detected for a predetermined third time or longer, the operation determination module 22 determines that a long tap operation is performed. When, after detection of an input position, the input position moves by a predetermined first distance or longer within a predetermined fourth time and then the input position is not detected any longer, the operation determination module 22 determines that a flick operation is performed. Further, the operation determination module 22 determines the direction of a flick operation on the basis of a first input position and an input position just before no input position is detected any longer. When the input position is detected and then moves by a predetermined second distance or longer, the operation determination module 22 determines that a slide operation is performed.

The operation determination module 22 determines the kind of an operation button touched by the user on the basis of an input position detected by the touch detection module 14 in the button operation identification mode. For determination of an operation button, the storage module 12 stores a data table indicative of relations between the operation buttons and the positions on the display surface 3, for example.

The function execution module 23 refers to the first assignment table in the touch operation identification mode to execute a function relating to telephone communications assigned to the kind of a touch operation determined by the operation determination module 22. Further, the function execution module 23 refers to the second assignment table in the button operation identification mode to execute a function relating to telephone communications assigned to the kind of an operation button determined by the operation determination module 22.

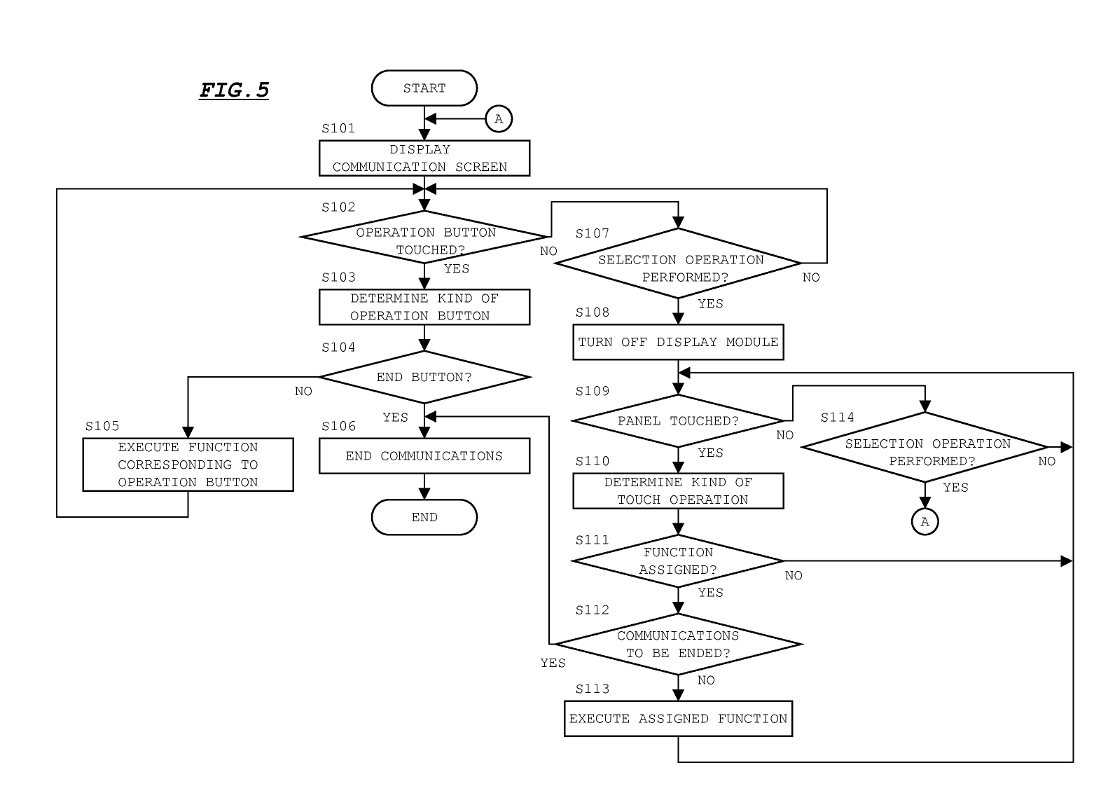

FIG. 5 is a flowchart showing a process for executing a function relating to telephone communications. When the telephone application is executed and a telephone network is established between the mobile phone 1 and the communication partner's device to start telephone communications, the executing process shown in FIG. 5 is started.

When telephone communications are started, first, the button operation identification mode is implemented. The display control module 21 displays the communication screen (refer to FIG. 3A) on the display surface 3 (S101). In the button operation identification mode, the user performs telephone communications while holding the mobile phone 1 to his/her ear (close to his/her ear) such that the front surface 2a of the cabinet 2, that is, the display surface 3 is faced to his/her ear.

The operation determination module 22 monitors to see whether the user touches any of the operation buttons 31 to 37 on the communication screen (S102). When a function relating to telephone communications is to be executed, the user releases the mobile phone 1 from his/her ear and touches a desired operation button.

When the user touches any of the operation buttons 31 to 37 (S102: YES), the operation determination module 22 determines the kind of the touched operation button (S103). The function execution module 23 refers to the second assignment table (FIG. 4B), and when the operation button determined by the operation determination module 22 is not the end button 31 (S104: NO), the function execution module 23 executes the function assigned to the touched operation button (S105). For example, when the up button 32 is touched, the function execution module 23 turns up the volume of the communication speaker 5, and when the down button 33 is touched, the function execution module 23 turns down the volume of the communication speaker 5. When the record button 34 is touched, the function execution module 23 starts recording, and stores voices of the communication partner received by the communication module 19 and voices of the user taken in from the microphone 4, in a predetermined recording region prepared in the storage module 12. When the stop button 35 is touched, the function execution module 23 stops the recording. When the hold button 36 is touched, the function execution module 23 stops temporarily the communications, and sends a predetermined holding tone to the communication partner's device. When the dial button 37 is touched, the function execution module 23 displays a numeric keypad including numeric keys of 1 to 9 and the like on the communication screen. The user can send a push signal by touching desired numeric keys.

Meanwhile, when the operation button determined by the operation determination module 22 is the end button 31 (S104: YES), the function execution module 23 ends the telephone communications (S106). At the end of the telephone communications, the display control module 21 closes the communication screen. The screen having been displayed before the execution of the telephone application, for example, is displayed again on the display surface 3.

While monitoring to see whether any of the operation buttons is touched (S102), the operation determination module 22 further monitors to see whether a selection operation for selecting the touch operation identification mode is performed (S107). When an operation key in the key operation part 6 assigned to the selection operation is pressed, the operation determination module 22 determines that the selection operation is performed (S107: YES).

When a touch operation, not a button operation, is desired, the user performs the selection operation to select the touch operation identification mode. When the selection operation is performed, the operation mode switches from the button operation identification mode to the touch operation identification mode. In the touch operation identification mode, the user performs telephone communications while holding the mobile phone 1 to his/her ear (close to his/her ear) such that the back surface 2b of the cabinet 2 is faced to his/her ear. The display surface 3 is faced to the opposite direction to the user's ear, and hence the user can touch the display surface 3 without the need to release the mobile phone 1 from his/her ear. Instead of the operation key in the key operation part 6, an operation button for the selection operation may be arranged on the communication screen.

When switched to the touch operation identification mode, the display control module 21 turns off the display module 13 (S108). The display surface 3 blacks out. The operation determination module 22 determines whether the display surface 3 is touched by the user (S109). When the display surface 3 is touched (S109: YES), the operation determination module 22 determines the kind of the touch operation (S110). The function execution module 23 refers to the first assignment table (FIG. 4A). When the kind of the touch operation determined by the operation determination module 22 is assigned a function (S111: YES) and the function assigned to the determined kind of the touch operation is not the function of ending communications (S112: NO), the function execution module 23 executes the assigned function (S113). For example, when the rightward flick operation is performed, the function execution module 23 increases the volume on the communication speaker 5, and when the leftward flick operation is performed, the function execution module 23 decreases the volume on the communication speaker 5. When the upward flick operation is performed, the function execution module 23 starts recording, and when the downward flick operation is performed, the function execution module 23 stops recording. When the double tap operation is performed, the function execution module 23 temporarily stops communications and sends a predetermined holding tone to the communication partner's device.

When the communications are to be ended, the user performs a long tap operation on the display surface 3. When the long tap operation is performed, the function execution module 23 determines that the assigned function is the function of ending communications (S112: YES), and terminates communications (S106). The display control module 21 turns on the display module 13. Accordingly, the screen having been displayed before the execution of the telephone application is displayed again on the display surface 3, for example.

While monitoring to see whether the display surface 3 is touched (S109), the operation determination module 22 further monitors to see whether a selection operation for selecting the button operation identification mode is performed (S114). When an operation key assigned to the selection operation in the key operation part 6 is pressed, the operation mode is switched from the touch operation identification mode to the button operation identification mode. The display control module 21 turns on the display module 13 and displays the communication screen on the display surface 3 (S101).

According to this embodiment as described above, the user can communicate even with the back surface 2b of the cabinet 2 faced to his/her ear. Further, the user can perform a touch operation (long tap operation, double tap operation, flick operation, or the like) on the display surface 3 faced to the opposite direction of his/her ear to execute a function relating to telephone communications such as volume control, according to the kind of the touch operation. Accordingly, the user can use a function relating to telephone communications by performing an operation on the display surface 3 while holding the mobile phone 1 to his/her ear to keep conversations with the communication partner.

According to this embodiment, the user can also execute functions relating to telephone communications by operating operation buttons on the display surface 3. In particular, each of the operation buttons generally carries an indication of a function assigned thereto, and thus the user can easily execute the assigned functions without the need to clearly remember the contents of the functions. The user can also execute functions hard to execute by a touch operation, such as transmission of push signals from a numeric keypad.

According to this embodiment, when the display module 13 is turned off in the touch operation identification mode, the display surface 3 becomes darker than in the button operation identification mode. This makes it possible to suppress power consumption of the mobile phone 1.

According to this embodiment, the communication speaker 5 includes the piezoelectric vibration element 50, and the piezoelectric vibration element 50 vibrates the cabinet 2 to output sound from the front surface 2a side and the back surface 2b side of the cabinet 2. This makes it possible to realize the mobile phone 1 that allows the user to listen to sounds from either of the front surface 2a side and the back surface 2b side of the cabinet 2 faced to his/her ear, without the need to provide the communication speaker 5 including separately a speaker outputting sounds from the front surface 2a and a speaker outputting sounds from the back surface 2b.

### Modification Example

Functions relating to telephone communications executed in the touch operation identification mode are not limited to the functions in the first embodiment.

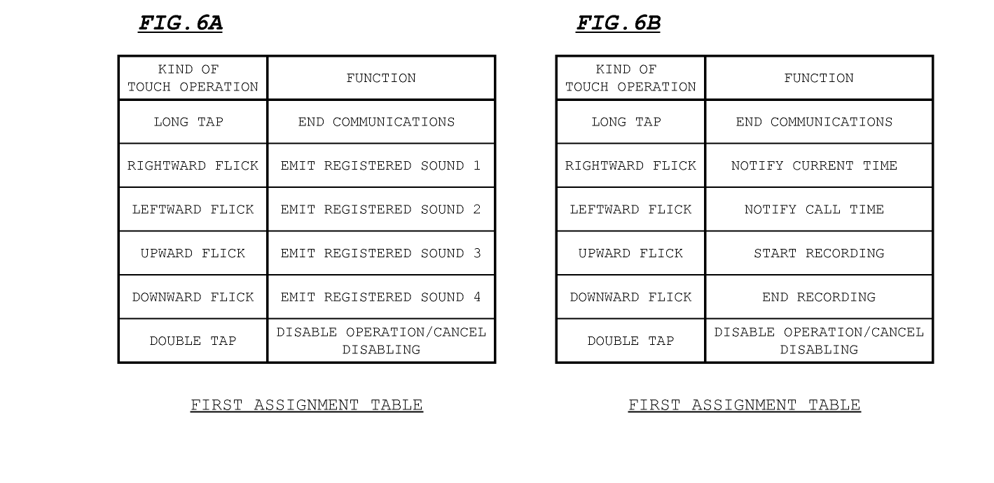

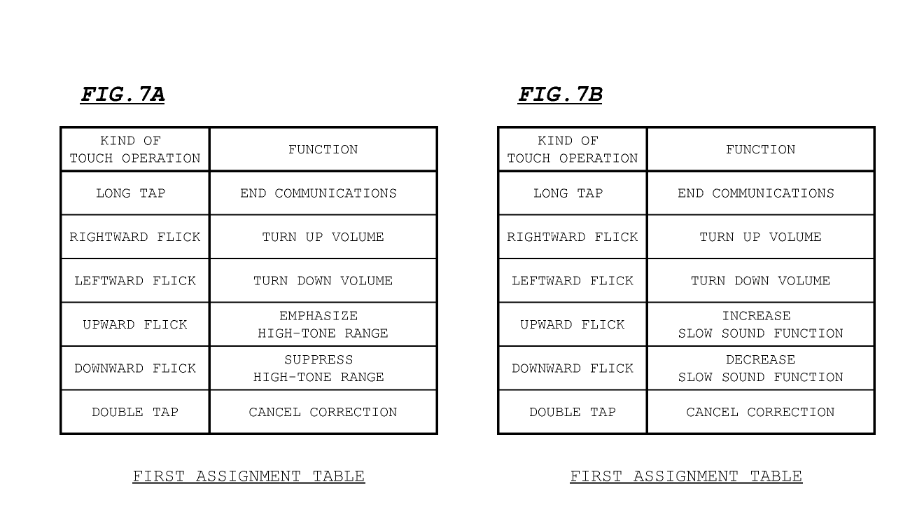

FIGS. 6A, 6B, 7A, and 7B are diagrams showing first assignment tables in the mobile phone 1 according to modification examples 1 to 4.

The mobile phone 1 according to the modification example 1 includes a function relating to telephone communications of sending registered sounds to a communication partner's device. As shown in FIG. 6A, the first assignment table provides assignment of functions “emit registered sound 1,” “emit registered sound 2,” “emit registered sound 3,” “emit registered sound 4,” and “disable an operation/cancel disabling” to touch operations “rightward flick,” “leftward flick,” “upward flick,” “downward flick,” and “double tap,” respectively. For example, the registered sound 1 may be a voice saying “Yes,” and the registered sound 2 may be a voice saying “No,” the registered sound 3 may be a voice saying “Pardon?,” and the registered sound 4 may be a voice saying “I see.”

The registered sounds are stored in a predetermined region of the storage module 12. The registered sounds may be stored in advance in the storage module 12, or sounds recorded through the microphone 4 may be stored as registered sounds in the storage module 12.

At step S113 in the process of executing a function relating to telephone communications, when the rightward flick operation, the leftward flick operation, the upward flick operation, or the downward flick operation is performed, the function execution module 23 reads a registered sound corresponding to the performed touch operation from the storage module 12, and sends the read registered sound to the communication partner's device through the communication module 19. When the double tap operation is performed, the function execution module 23 disables the touch operations other than the double tap operation, that is, does not accept the touch operations other than the double tap operation. When the double tap operation is performed while the touch operations other than the double tap operation are disabled, the function execution module 23 cancels the disabling, that is, accepts all the touch operations.

According to the configuration in the modification example 1, even when the user's voice is unlikely to reach the communication partner due to loud ambient noise, the user can send registered sounds to communicate with the communication partner at a certain level.

The mobile phone 1 according to the modification example 2 mainly includes functions relating to telephone communications of providing communication information. As shown in FIG. 6B, the first assignment table provides assignment of functions “notify current time,” “notify call time,” and “disable an operation/cancel disabling” to the touch operations of “rightward flick,” “leftward flick,” and “double tap,” respectively, for example.

At step S113 in the process of executing a function relating to telephone communications, when the rightward flick operation is performed, the function execution module 23 outputs a sound notifying the current time from the communication speaker 5. When the leftward flick operation is performed, the function execution module 23 outputs a sound notifying the call time from the communication speaker 5. When the double tap operation is performed, the function execution module 23 disables the touch operations other than the double tap operation, and when the double tap operation is performed while the touch operations other than the double tap operation are disabled, the function execution module 23 cancels the disabling. The communication information may include other information such as the communication partner's telephone number and mail address.

The mobile phone 1 according to the modification examples 3 and 4 mainly includes functions relating to telephone communications of correcting received sounds. In the modification example 3, as shown in FIG. 7A, the first assignment table provides assignment of functions “emphasize high-tone range,” “suppress high-tone range,” and “cancel correction” to the touch operations of “upward flick,” “downward flick,” and “double tap,” respectively, for example.

At step S113 in the process for executing a function relating to telephone communications, when the upward flick operation is performed, the function execution module 23 corrects sound signals of sound received after the operation to emphasize a high-tone range. Accordingly, the communication speaker 5 outputs sounds with the high-tone range emphasized. When the downward flick operation is performed, the function execution module 23 corrects sound signals of sound received after the operation to suppress the high-tone range. Accordingly, the communication speaker 5 outputs sounds with the high-frequency range suppressed. When the double tap operation is performed, the function execution module 23 terminates the correction of the high-frequency tone of received sounds. Accordingly, the received sounds return to normal state.

In the modification example 4, as shown in FIG. 7B, the first assignment table provides assignment of the functions “increase slow sound function,” “decrease slow sound function,” and “cancel correction” to the touch operations of “upward flick,” “downward flick,” and “double tap,” respectively, for example.

At step S113 in the process for executing a function relating to telephone communications, when the upward flick operation is performed, the function execution module 23 lowers the speed of reproduction of sounds received after the operation. The reproduction speed is more lowered at each execution of the upward flick operation. When the downward flick operation is performed while the reproduction speed is lower, the function execution module 23 raises the reproduction speed. When the speed of reproduction of received sounds is normal, even when the downward flick operation is performed, the function execution module 23 does not raise the reproduction speed. When the double tap operation is performed, the function execution module 23 terminates the correction of slowing received sounds. Accordingly, the speed of reproduction of received sounds returns to normal state.

According to the configuration in the modification examples 3 and 4, the user can control received sounds so as to be easily heard.

In the mobile phone 1 according to the modification examples 1 to 4, the communication screen including the operation buttons corresponding to the functions is displayed on the display surface 3 in the button operation identification mode. When any of the operation buttons is touched, the function assigned to the touched operation button is executed.

### Second Embodiment

The mobile phone 1 of this embodiment, besides the normal telephone application, includes an application for telephone communications in a half-duplex communication system, that is, a push-to-talk communication system (hereinafter, referred to “PTT communications”). When the PTT communication application is executed and a communication network is established among the user's device (the mobile phone 1), a communication partner's device, and a management server that mediates communications between the two devices, the user's device and the communication partner's device can communicate with each other. When one of the devices performs a send operation, the management server grants the device the right to speak. The right to speak is held while the send operation is continued. When the device with the right to speak outputs a sound, the output sound is sent from the management server to the device without the right to speak. At the end of the send operation, the right to speak is lost. The device without the right to speak outputs no sound. The PTT communication system allows group communications among three or more devices.

When telephone communications are started, functions relating to PTT communications such as a function to obtain the right to speak are executed according to predetermined input operations. In the mobile phone 1 of this embodiment, only the touch operation identification mode is implemented as operation mode. Various touch operations on the display surface 3 are assigned to functions relating to PIT communications. When the user performs a specific touch operation, the function corresponding to the touch operation is executed.

The configuration of the mobile phone 1 in this embodiment is identical to that in the first embodiment, and the mobile phone 1 includes the components shown in FIGS. 1 and 2.

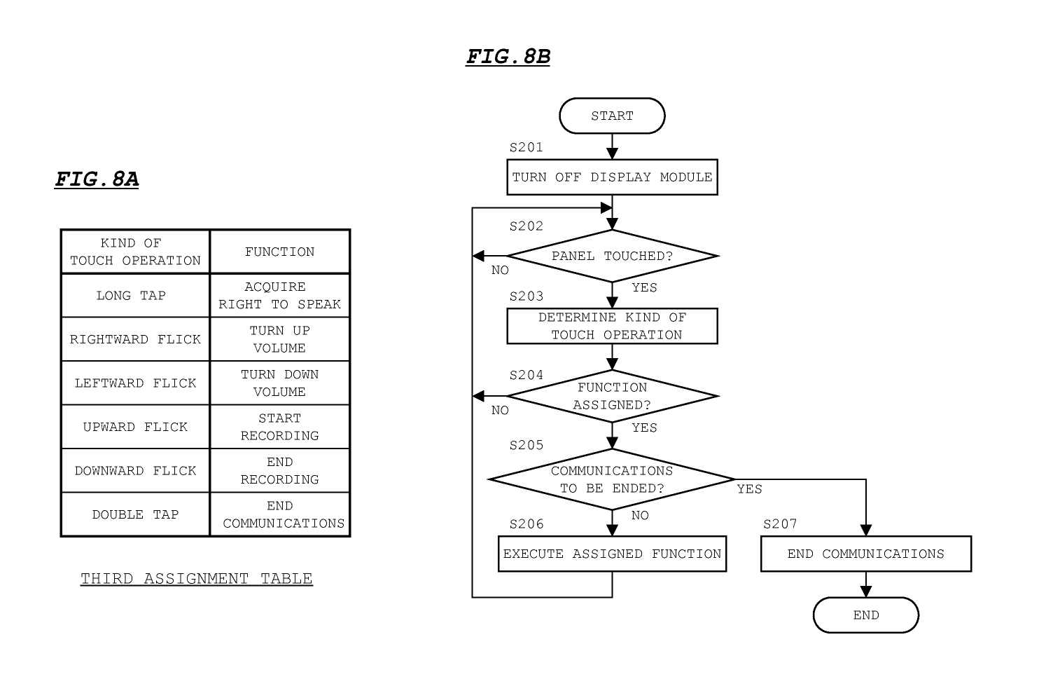

FIG. 8A is a diagram showing a third assignment table providing correspondence between touch operations and functions relating to PTT communications, and FIG. 8B is a flowchart showing a process for executing a function relating to PTT communications.

The assignment table 12a includes the third assignment table. As shown in FIG. 8A, the third assignment table provides assignment of individual functions relating to PTT communications to the individual kinds of touch operations. For example, the functions “acquire the right to speak,” “turn up volume,” “turn down volume,” “start recording,” “end recording,” and “end communications” are assigned to the touch operations “long tap,” “rightward flick,” “leftward flick,” “upward flick,” “downward flick,” and “double tap,” respectively, for example. In this embodiment, the long tap operation constitutes the above-mentioned send operation in PTT communications.

When the PTT communication application is executed and communications with a communication partner's device are started, an executing process shown in FIG. 8B is started. On PTT communications, the user holds the mobile phone 1 to (close to) his/her ear such that the back surface 2b of the cabinet 2 faces his/her ear.

When the communications are started, the display control module 21 turns off the display module 13 (S201). The display surface 3 blacks out. The operation determination module 22 determines whether the display surface 3 is touched by the user (S202). When the display surface 3 is touched (S202: YES), the operation determination module 22 determines the kind of the touch operation (S203). The function execution module 23 refers to the third assignment table (FIG. 8A). When any function is assigned to the kind of the touch operation determined by the operation determination module 22 (S204: YES) and the function assigned to the determined kind of the touch operation is not the function to end communications (S205: NO), the function execution module 23 executes the assigned function (S206).

For example, when the long tap operation is performed, the function execution module 23 sends a request command to the management server and acquires the right to speak from the management server. After that, the function execution module 23 sends voices of the user input from the microphone 4 to the management server. When the long tap operation is ended and the user's finger is released from the display surface 3, the function execution module 23 sends a cancel command to the management server and abandons the right to speak. While performing the long tap operation, the user can speak to a partner as a destination of the sending.

When the communications are to be ended, the user performs the double tap operation on the display surface 3. When the double tap operation is performed, the function execution module 23 determines that the assigned function is the function of end communications (S205: YES), and ends the communications (S207). The display control module 21 turns on the display module 13. The screen having been displayed before the execution of the PTT communication application is displayed again on the display surface 3, for example.

According to this embodiment, the user can perform the send operation (to acquire the right to speak) in PTT communications on the display surface 3, and speak to the communication partner, without the need to release the mobile phone 1 from his/her ear.

### Third Embodiment

In the mobile phone 1 according to this embodiment, the user can select in advance functions relating to telephone communications to be assigned to the kinds of touch operations in the touch operation identification mode.

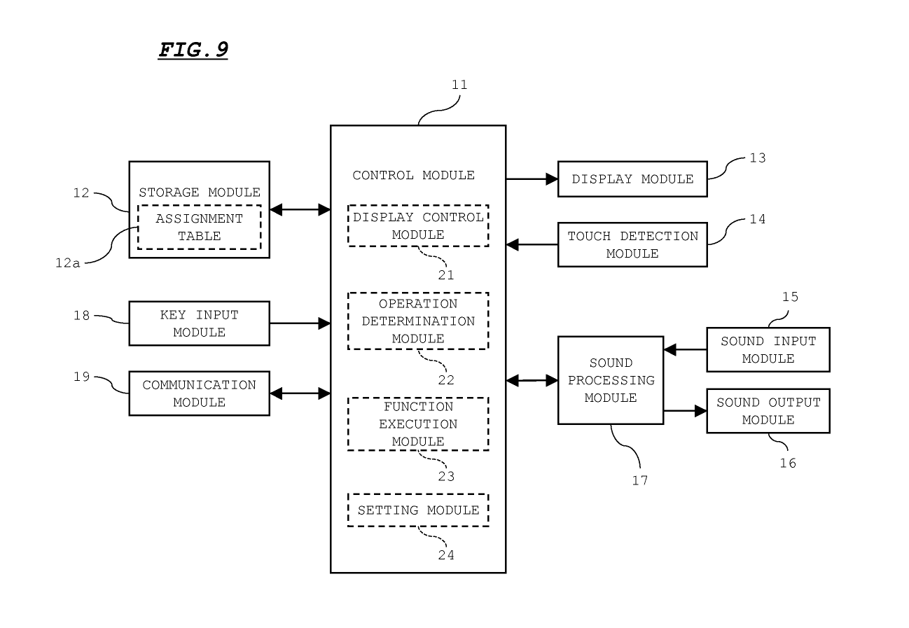

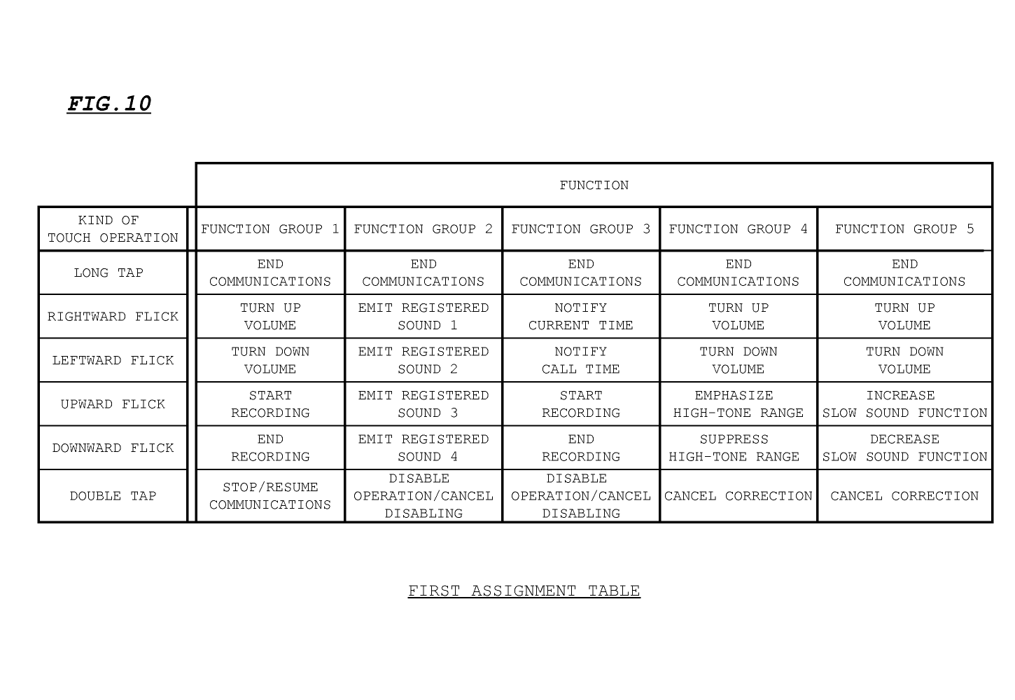

FIG. 9 is a block diagram showing an entire configuration of the mobile phone 1 according to this embodiment. FIG. 10 is a diagram showing a first assignment table in the mobile phone 1 according to this embodiment.

As shown in FIG. 9, the control module 11 includes a setting module 24 to set functions relating to telephone communications to be assigned to the kinds of the touch operations. As shown in FIG. 10, the first assignment table includes a plurality of user-selectable function groups (function groups 1 to 5). For example, functions belonging to the function groups 1 to 5 correspond to the functions described in relation to the first embodiment and modification examples 1 to 4, respectively, for example.

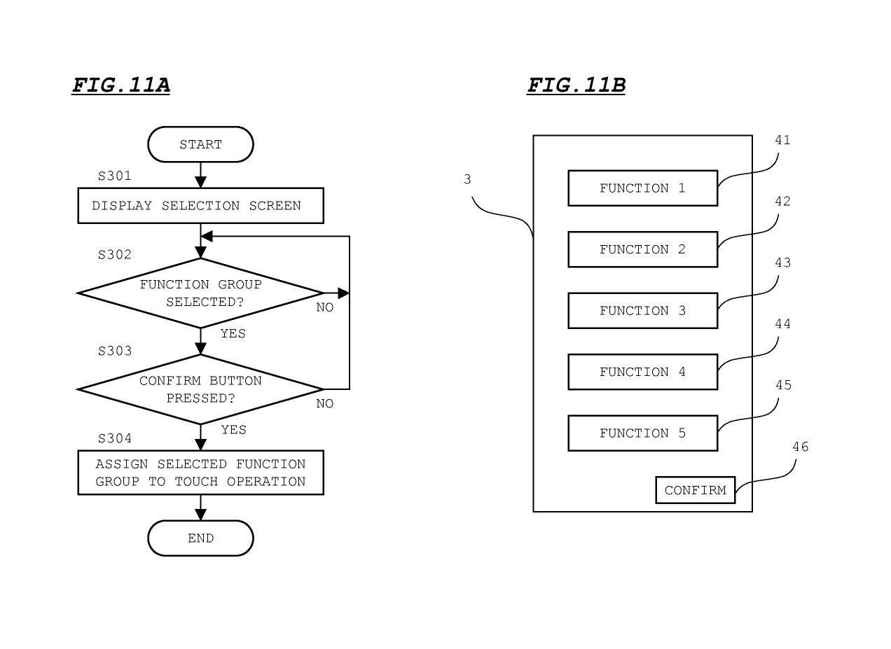

FIG. 11A is a flowchart showing a function setting process for setting functions relating to telephone communications to be assigned to the kinds of touch operations. FIG. 11B is a diagram showing one example of a selection screen for the user to select a function group.

When the function setting process is started according to the user's predetermined operation, the display control module 21 displays the selection screen on the display surface 3 (S301). For example, as shown in FIG. 11B, the selection screen includes selection buttons 41 to 45 corresponding to the function groups 1 to 5 and a confirm button 46.

The user touches a desired selection button to select the function group, and then touches the confirm button 46.

When the function group is selected (S302: YES) and then the confirm button 46 is touched (S303: YES), the setting module 24 assigns the selected function group to the touch operation (S304).

When the telephone application is executed and communications are started, the process for executing a function relating to telephone communications shown in FIG. 5 is started as in the first embodiment. When the user performs a touch operation in the touch operation identification mode, the function execution module 23 executes at step S113 the function assigned to the touch operation performed by the user, in the function group set by the setting module 24.

In the mobile phone 1 according to this embodiment, the communication screen including the operation buttons corresponding to the functions belonging to the function group set by the setting module 24 is displayed on the display surface 3 in the button operation identification mode. When any of the operation buttons is touched, the function assigned to the touched operation button is executed.

According to this embodiment, the user can select functions to be capable of being used during communications, which makes it possible to improve user convenience.

### Others

As in the foregoing, embodiments and modification examples of the present invention are described. However, the present invention is not limited by the foregoing embodiments and the like, and the embodiments of the present invention can be modified in various manners other than those described above.

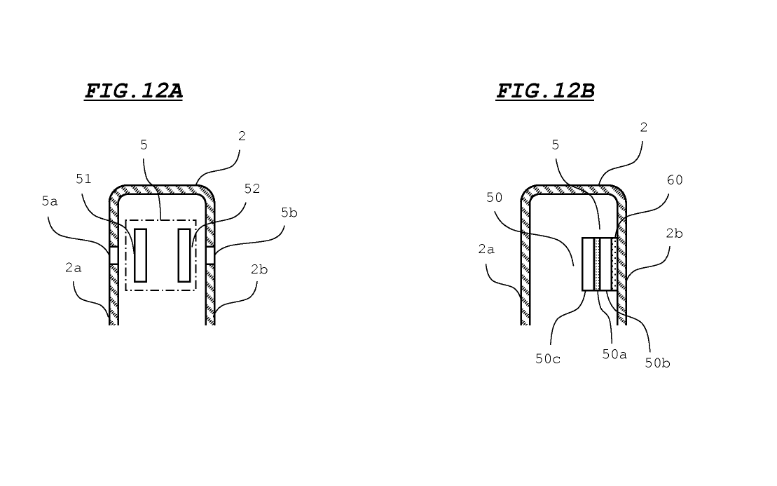

For example, in the first embodiment, the communication speaker 5 includes the piezoelectric vibration element 50. As shown in FIG. 12A, however, the communication speaker 5 may include a first speaker 51 on the front surface 2a side of the cabinet 2 and a second speaker 52 on the back surface 2b side of the cabinet 2. The cabinet 2 includes a first output hole 5a and a second output hole 5b on the front surface 2a and the back surface 2b thereof, respectively. Sounds from the first speaker 51 are output to the outside through the first output hole 5a. Sounds from the second speaker 52 are output to the outside through the second output hole 5b.

In the first embodiment, when telephone communications are started, the button operation identification mode is first set, and then the operation mode is switched to the touch operation identification mode by the user's selection operation. Alternatively, when telephone communications are started, the touch operation identification mode may be first set, and after that, switched to the button operation identification mode by the user's selection operation. In addition, instead of switching the operation mode by the user's selection operation during telephone communications, the user may select in advance on a predetermined selection screen the button operation identification mode or the touch operation identification mode to be set. In this case, when telephone communications are started, the pre-selected operation mode is implemented.

In the first embodiment, the button operation identification mode and the touch operation identification mode are selectively implemented on the telephone application. However, the present invention is not limited to this but only the touch operation identification mode may be implemented on the telephone application, as with the PTT communication application. In this case, the user mainly performs communications with the back surface 2b of the cabinet 2 faced to his/her ear. Accordingly, as shown in FIG. 12B, the piezoelectric vibration element 50 included in the communication speaker 5 is desirably attached to the back surface 2b of the back surface 2b. Alternatively, the communication speaker 5 may include only the second speaker 52 on the back surface 2b side shown in FIG. 12A.

In the first embodiment, the double tap operation, the long tap operation, and the flick operation are used as touch operations for executing the functions relating to telephone communications. Alternatively, a slide operation may be used as a touch operation for executing the functions relating to telephone communications. In this case, upward, downward, rightward, and leftward slide operations and a clockwise circling slide operation and a counterclockwise circling slide operation may be used.

In the first embodiment, when the user has the back surface 2b of the cabinet 2 faced to his/her ear, smaller sounds are transferred to the user as compared to the case where the user has the front surface 2a of the cabinet 2 faced to his/her ear. Accordingly, in the touch operation identification mode in which the user has the back surface 2b of the cabinet 2 faced to his/her ear, the control module 11 may turn up the volume of the communication speaker 5 so as to be larger than in the button operation identification mode.

In the first embodiment, when the touch operation identification mode is implemented, the display module 13 is turned off and the display surface 3 becomes darker than in the button operation identification mode. Alternatively, when the touch operation identification mode is implemented, the display surface 3 may become darker than in the button operation identification mode by making the brightness of the display module 13 lower than in the button operation identification mode. In this case, in the touch operation identification mode, the display surface 3 becomes darker than in the button operation identification mode but does not black out.

In the first embodiment, in the touch operation identification mode, the function to end telephone communications is assigned to one kind of touch operation. At the end of the call, however, the conversation with the communication partner is already ended, and thus there is no problem for the user to release the mobile phone 1 from his/her ear. Accordingly, the end button assigned to the function to end telephone communications may be displayed on the display surface 3. In this case, the end button is desirably placed at a position not interfering with the touch operations, such as at a lower end part of the display surface 3.

In the third embodiment, the user selects from a plurality of function groups a function group to be assigned to the touch operations. That is, the user selects collectively the functions to be assigned to the touch operations. However, the selection method is not limited to this but, for example, the user may select, from a plurality of functions relating to telephone communications, functions to be assigned to the kinds of the touch operations one by one.

In the first and second embodiments, when a touch operation assigned to the function relating to telephone communications is performed, the external speaker 7 may output a notification sound such as a beep. In the case where the mobile phone 1 is provided with a vibration device, the mobile phone 1 may vibrate by activation of the vibration device. This allows the user to recognize that the touch operation is accepted. In addition, after execution of a function relating to telephone communications, the external speaker 7 may output a sound notifying of the execution. For example, when recording is started, the message saying “recording is started” is issued. This allows the user to recognize that the function is executed.

The functions relating to telephone communications to be executed during telephone communications are not limited to the functions in the first to third embodiments and the modification examples. For example, a mute function may be executed such that the user's voices are not sent to a communication partner's device.

In the first embodiment, the present invention is applied to smart phone-type mobile phones. However, the application of the present invention is not limited to this but the present invention may be applied to other types of mobile phones such as a straight type, a folding type, and a slide type.

What is claimed is:

1. A mobile electronic device capable of telephone communications with another device, comprising:
a display module disposed on a first surface of a housing;
a sound output module operable to generate vibrations based on received sounds and transfer the vibrations to a second surface of the housing opposed to the first surface, the sound output module being disposed within the housing;
a touch detection module operable to detect a touch operation performed by a user on the display module;
an operation determination module operable to determine the kind of the touch operation during the telephone communications with the another device; and
a function execution module operable to execute a function assigned to the determined kind of the touch operation, the function being relating to the telephone communications.

2. The mobile electronic device according to claim 1, further comprising:
an execution module operable to execute selectively at least a first mode or a second mode as a mode relating to the telephone communications; and
a display control module operable to control the display module, wherein
in the first mode, the operation determination module determines the kind of the touch operation during the telephone communications, and the function execution module executes a function relating to the telephone communications assigned to the kind of the touch operation determined by the operation determination module, and
in the second mode, the display control module displays operation buttons on the display module during the telephone communications, the operation determination module determines the kind of the operated operation button based on results of detection by the touch detection module, and the function execution module executes a function relating to the telephone communications assigned to the kind of the operation button determined by the operation determination module.

3. The mobile electronic device according to claim 2, wherein the display control module sets brightness of the display module in the first mode to be lower than brightness of the display module in the second mode.

4. The mobile electronic device according to claim 1, further comprising a setting module that sets a function assigned to the kind of the touch operation according to a user's operation.

5. The mobile electronic device according to claim 1, further comprising a sound holding module which holds sounds, wherein
the function assigned to the touch operation comprises a function to read the sounds from the sound holding module and send the sounds to another device.

6. The mobile electronic device according to claim 1, wherein the function assigned to the touch operation comprises a function to acquire a right to send sounds to another device during the telephone communications in a half-duplex communication system.

7. A method for operating a mobile electronic device, the method comprising:
receiving sound data from another device;
generating vibrations based on the received sound data;
transferring the generated vibrations to a second surface opposed to a first face with a display module, thereby to transfer the sounds to a user;
detecting a touch operation performed by the user on the display module;
determining the kind of the touch operation during telephone communications with the another device; and
executing a function relating to the telephone communications that is assigned to the determined kind of the touch operation.
